(19) United States
(12) Patent Application Publication
(10) Pub. No.: US 2010/0138550 A1
(43) Pub. Date: Jun. 3, 2010

(54) SHIP-BORNE DEVICE MANAGING METHOD

(76) Inventors: Kwangil LEE, Daejeon (KR); Jun Hee PARK, Daejeon (KR); Chang Eun LEE, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/480,815

(22) Filed: Jun. 9, 2009

(30) Foreign Application Priority Data
Dec. 1, 2008 (KR) 10-2008-0120795
Mar. 12, 2009 (KR) 10-2009-0021370

(51) Int. Cl. G06F 15/16

(52) U.S. Cl. 709/228; 709/227

(57) ABSTRACT

A ship-borne device managing method includes allocating IP address information to a device when a device configuration information request message is received from the device through a network in a ship system; performing an overlapping test of checking whether the allocated IP address information is currently used in the device; allocating service session information necessary for provision of an application service regarding the device in case where the overlapping test determines that the allocated IP address information is not currently used by the device; and generating a device configuration information response message based on the allocated IP address information and service session information and transmitting the device configuration information response message to the device. The device configuration information request message may include information regarding the device in the form of text or binary.

### CROSS-REFERENCE(S) TO RELATED APPLICATION(S)

The present invention claims priority of Korean Patent Applications No. 10-2009-0021370, filed on Mar. 12, 2009, and 10-2008-0120795, filed on Dec. 1, 2008, which are incorporated herein by reference.

### FIELD OF THE INVENTION

The present invention relates to a technology for automatically managing various devices in a ship; and, more particularly, to a method for managing one or more ship-borne devices suitable for automatically providing plug-and-play (PnP) services to a ship system without interference of a user by automatically managing configuration of the devices in the ship when they are installed or replaced.

### BACKGROUND OF THE INVENTION

Recent development of e-navigation system paved the way for a TCP/IP network such as the Ethernet instead of a traditional field bus protocol to be used by devices in a ship and requires that ship systems that were individually operated in the past be integrated into one integrated network system.

Development of an integrated ship system and an increase in the number of network devices require communication between devices in one system or different systems. For such communication to be established, the devices in the ship need to configure session information for setting sessions of various application services as well as their own IP addresses.

Although the IP addresses or session information of the devices in the ship ideally needs to be dynamically managed, it is not easy due to complex functions necessary for management of the system and an increase in construction costs.

Generally, since simple devices such as a navigation device of a ship have fixed network addresses and communicate with other devices based on predefined session information, the ship system may malfunction if the ship-borne devices are constructed without full understanding of a predefined configuration mechanism.

In particular, when a broken device is unduly replaced due to a carelessness of a crew unfamiliar with the construction of the ship-borne device, it seriously affects safety of the ship.

Therefore, a technical solution for allowing a ship to automatically recognize a device in a ship without interference of a user and allowing devices to automatically configure a system is necessary.

### SUMMARY OF THE INVENTION

It is, therefore, a primary object of the present invention to provide a ship-borne device managing technology allowing services and devices in a ship to automatically provide plug-and-play services to a ship network system.

It is another object of the present invention to automatically perform a plug-in of a device and a plug-in of a service by providing IP address information and session information regarding a service to be provided according to feature information of devices connected to a network system in a ship.

In accordance with an embodiment of the present invention, there is provided a ship-borne device managing method including allocating IP address information to a device when a device configuration information request message is received from the device through a network in a ship system; performing an overlapping test of checking whether the allocated IP address information is currently used in the device; allocating service session information necessary for provision of an application service regarding the device in case where the overlapping test determines that the allocated IP address information is not currently used by the device; and generating a device configuration information response message based on the allocated IP address information and service session information and transmitting the device configuration information response message to the device.

The device configuration information request message may include information regarding the device in the form of text or binary.

The information regarding the device may be constituted by information regarding a type, a name or a configuration of the device.

The overlapping test may be performed for the IP address information allocated to the device by using an address resolution protocol (ARP)

The device configuration information response message may include the IP address information and session information.

The session information may include name information of a service, port information regarding a protocol of the service, and IP address information of a destination.

In accordance with another embodiment of the present invention, there in provided a ship-borne device managing method including initializing connection of a network in correspondence to supply of power to a ship system; acquiring feature information regarding a configuration and a service; transmitting a device configuration information request message corresponding to the acquired feature information through the network; performing an overlapping test of detecting IP address information from the device configuration information response message and determining whether the IP address is currently used when the device configuration information response message is received through the network; acquiring service detail information including service session information necessary for provision of IP address information and an application service when the overlapping test determines the detected IP address information not to be overlapped; and setting a service session using the acquired service session information.

The device configuration information request message may include device information in the form of text or binary.

The device configuration information response message information may include the IP address information and session information.

The overlapping test may be performed by carrying out MAC broadcasting through the network.

The invention automatically manages configuration of ship-borne devices when the ship-borne devices are installed or replaced so that it conveniently and automatically provides a plug-and-play service even in case where a user lacks a special knowledge about a ship-borne device or a ship system.

### BRIEF DESCRIPTION OF THE DRAWINGS

The above and other aspects and features of the invention will become apparent from the following description of embodiments given in conjunction with the accompanying drawings, in which:

FIG. 1 is a schematic block diagram of a ship system for realizing a ship-borne device managing method in accordance with an embodiment of the invention;

FIG. 2 is an exemplary flowchart of a ship-borne device managing method in accordance with the embodiment of the invention; and

FIG. 3 is an exemplary flowchart of a ship-borne device managing method in accordance with an embodiment of the invention.

### DETAILED DESCRIPTION OF THE PREFERRED EMBODIMENTS

Hereinafter, embodiments of the invention will be described in detail with reference to the accompanying drawings.

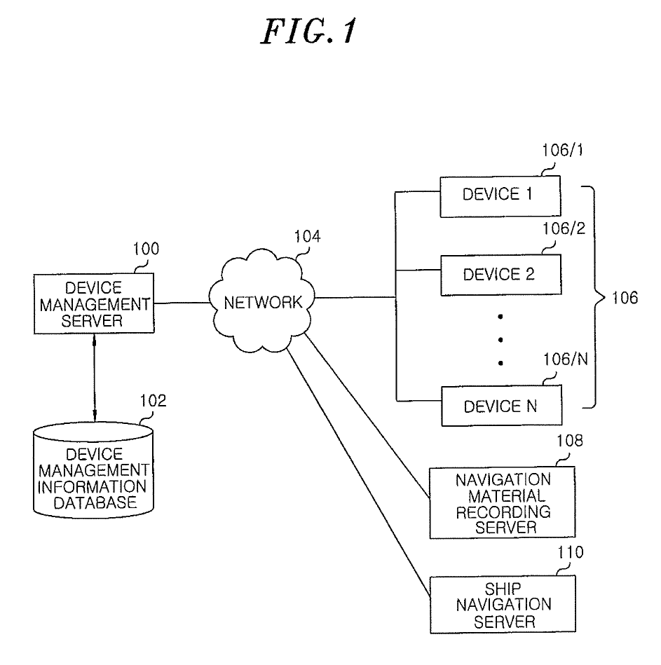

FIG. 1 is a schematic block diagram of a ship system for realizing a ship-borne device managing method in accordance with an embodiment of the invention. The device managing system includes a device management server 100, a device management information database 102, a network 104, a device group 106, a navigation material recording server 108 and a ship navigation server 110.

As illustrated in FIG. 1, the device management server 100 manages equipments connected through the network 104 of the ship system such as the device group 106, the navigation material recording server 108 and the ship navigation server 110 and also manages device configuration information and service configuration information stored in the device management information database 102.

For example, when an arbitrary device (such as the first device 106/1) is newly connected to the network 104, the device management server 100 receives a device configuration information request message from the first device 106/1 and immediately transmits a device configuration information response message corresponding to the device configuration information request message to the first device 106/1, or stores the device configuration information response message in the device management information database 102 before transmitting the device configuration information response message to the first device 106/1.

Here, the device configuration information request message may contain device information in form of text or binary, and the device information may contain the type, the name and the configuration of the device. Further, the device configuration information response message may contain IP information and session information.

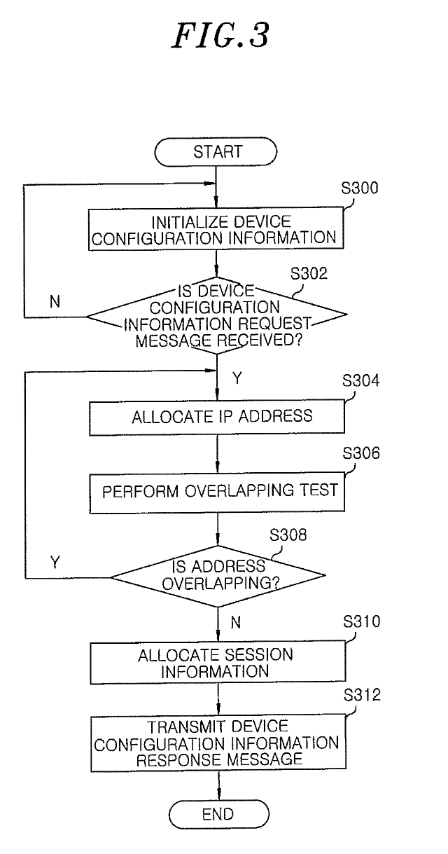

The device management server 100 will be described later in detail with reference to FIG. 3.

The network 104 is, for example, a TCP/IP network and provides an environment in which the device group 106, the navigation material recording server 108 and the ship navigation server 110 and the like, which will be described later, can be integrally connected to the device management server 100.

The device group 106 includes a plurality of devices 106/1 to 106/N and is connected to the device management server 100 through the network 104. When an arbitrary device of the device group 106, for example, the first device 106/1 is newly connected to the network 104, the first device 106/1 sets a communication channel to the device management server 100 and transmits device configuration information request message containing the type, name, and configuration of the device through the set communication channel. Further, the first device 106/1 receives the device configuration information response message from the device management server 100 to set a service session of the device and start a service.

The navigation material recording server 108 records and manages a navigation material of the ship by using a black box and provides the navigation material to the device management server 100 through the network 104.

The ship navigation server 110 is, for example, an inertial navigation system and provides navigation execution information of the ship or the like to the device management server 100 through the network 104.

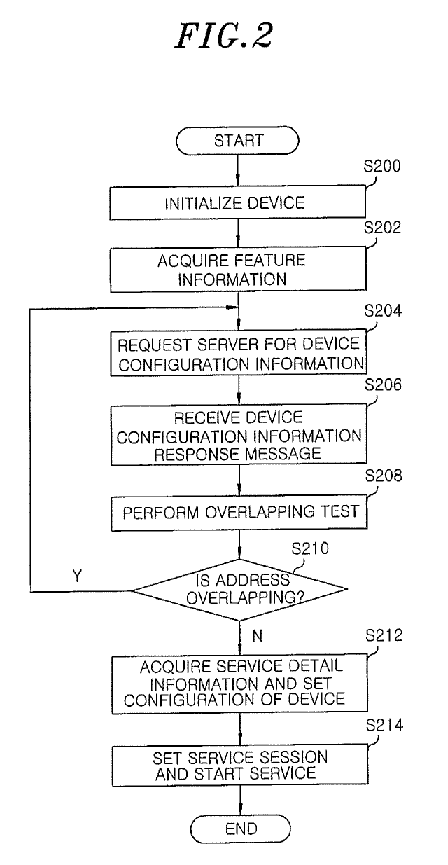

Hereinafter, considering the above-mentioned configuration, a ship-borne device managing method in accordance with an embodiment of the invention will be described in detail with reference to FIGS. 2 and 3.

First, FIG. 2 illustrates a ship-borne device managing method in accordance with the embodiment of the present invention, in more detail, an exemplary process of allowing a ship-borne device to request device configuration information and receive a response message to the requested device configuration information to set the configuration of a device.

As exemplified in FIG. 2, when power is supplied to a ship system (not shown), an arbitrary device of the device group 106, for example, the first device 106/1 is initialized (S200). The initialization of the system may include a process of activating an interface of the network 104 connected to the first device 106/1.

After the initialization of the system, the first device 106/1 acquires feature information regarding configuration of a device and a provided service (S202).

After the first device 106/1 acquires the feature information, it requests device configuration information corresponding to the feature information of the first device 106/1 from the device management server 100 through the activated network 104 (S204). For example, the first device 106/1 may transmit the device configuration information request message to the device management server 100. Here, the device configuration information request message may contain the device information in the form of text or binary, and the device information may contain the type, name, and configuration of the device.

Then, the first device 106/1 receives a device configuration information response message from the device management server 100 (S206). Here, the device configuration information response message may contain IP information, session information and the like, and the session information may contain, for example, the name of each service, port information regarding protocol (TCP, UDP or the like) of the service, an IP address of a destination, and the name of a destination service. Further, the session information may, for example, use a protocol type of an Ethernet frame, allocate one SNAP number, or be communicated with a TCP/IP based application service.

Then, the first device 106/1 performs an overlapping test of detecting IP address information from the received device configuration information response message and determining that the IP address is currently used in the device 106/1 (S208).

The overlapping test may be realized, for examples, by carrying out media access control (MAC) broadcasting through the network 104 using an address resolution protocol (ARP) by the first device 106/1.

When the overlapping test determines that the detected IP address information is overlapped, service detail information containing IP address information regarding the first device 106/1 and service session information necessary for provision of an application service and a basic configuration for a service of the first device 106/1 is set (S210 and S212).

When the detected IP address information is determined to be overlapped, the first device 106/1 is fed back to the step S204 to request the device management server 100 for device configuration information corresponding to the feature information of the first device 106/1.

Afterward, the first device 106/1 may set service sessions with other devices and start a corresponding service by utilizing the acquired service session information (S214).

FIG. 3 illustrates a ship-borne device managing method in accordance with the embodiment of the invention, in more detail, an exemplary process of allowing the device management server 100 to receive a device configuration information request message and transmit a response message to manage the configuration of the device.

First, the device management server 100 stores information regarding a configuration of a ship-borne device such as IP address information of devices connected to the network 104 and TCP/UDP protocol information and port information regarding services in the form of a database, and provides a response message whenever the device group 106 requests device configuration information.

As illustrated in FIG. 3, if device configuration information is initialized (S300), the device management server 100 determines whether a device configuration information request message is received from an arbitrary device of the device group 106, for example, the first device 106/1 (S302). Then, the device configuration information request message may contain text or binary device information and the device information may contain the type of a device, the name of the device, and the configuration of the device.

After the device configuration information request message is received from the first device 106/1, the device management server 100 allocates IP address information of the first device 106/1 (S304) and performs an overlapping test of checking through ARP the allocated IP address is currently used by the current first device 106/1 (S306). Such an overlapping test can be performed, for example, by allowing the device management server 100 to use ARP with respect to the address allocated to the first device 106/1, monitoring traffic on the network 104, and monitoring a response signal for a determined period of time or a determined number of times after transmitting a query message with respect to the address allocated to a communication device through a separate communication mechanism.

When the overlapping test determines the allocated IP address is not currently used, service session information necessary for provision of an application service to the first device 106/1 is allocated (S308 and S310).

On the other hand, if the allocated IP address information is determined to be overlapped, the device management server 100 is fed back to step S304 and allocates new IP address information, i.e., IP address information different from the first allocated IP address information.

After the IP address information and session information are allocated, the device management server 100 generates a device configuration information response message and transmits the generated device configuration information response message to the first device 106/1 (S312).

Here, the device configuration information response message may contain, for example, IP address information, session information and the like. The session information may contain, for example, the name of each service, port information regarding protocol (TCP, UDP or the like) of the service, an IP address of a destination, and the name of a destination service. Further, the session information may, for example, use a protocol type of an Ethernet frame, allocate one SNAP number, or be communicated with a TCP/IP based application service.

As described above, in the embodiments of the invention, those unfamiliar with the function of a ship system can be automatically provided with a plug-and-play service when a new device is set in the ship system or an existing device is replaced by another device, by automatically setting configuration information of various devices of the ship system.

While the invention has been shown and described with respect to the embodiments, it will be understood by those skilled in the art that various changes and modifications may be made without departing from the scope of the invention as defined in the following claims.

What is claimed is:

1. A ship-borne device managing method, comprising:
allocating IP address information to a device when a device configuration information request message is received from the device through a network in a ship system;
performing an overlapping test of checking whether the allocated IP address information is currently used in the device;
allocating service session information necessary for provision of an application service regarding the device in case where the overlapping test determines that the allocated IP address information is not currently used by the device; and
generating a device configuration information response message based on the allocated IP address information and service session information and transmitting the device configuration information response message to the device.

2. The ship-borne device managing method of claim 1, wherein the device configuration information request message includes information regarding the device in the form of text or binary.

3. The ship-borne device managing method of claim 2, wherein the information regarding the device is constituted by information regarding a type, a name or a configuration of the device.

4. The ship-borne device managing method of claim 1, wherein the overlapping test is performed for the IP address information allocated to the device by using an address resolution protocol (ARP)

5. The ship-borne device managing method of claim 1, wherein the device configuration information response message includes the IP address information and session information.

6. The ship-borne device managing method of claim 5, wherein the session information includes name information of a service, port information regarding a protocol of the service, and IP address information of a destination.

7. A ship-borne device managing method, comprising:
initializing connection of a network in correspondence to supply of power to a ship system;
acquiring feature information regarding a configuration and a service;
transmitting a device configuration information request message corresponding to the acquired feature information through the network;
performing an overlapping test of detecting IP address information from the device configuration information response message and determining whether the IP address is currently used when the device configuration information response message is received through the network;
acquiring service detail information including service session information necessary for provision of IP address information and an application service when the overlapping test determines the detected IP address information not to be overlapped; and
setting a service session using the acquired service session information.

8. The ship-borne device managing method of claim 7, wherein the device configuration information request message includes device information in the form of text or binary.

9. The ship-borne device managing method of claim 7, wherein the device configuration information response message information includes the IP address information and session information.

10. The ship-borne device managing method of claim 7, wherein the overlapping test is performed by carrying out MAC broadcasting through the network.
